(19) United States
(12) Patent Application Publication
(10) Pub. No.: US 2013/0332849 A1
(43) Pub. Date: Dec. 12, 2013

(54) EMAIL CONTENT SHARING

(71) Applicant: Paulo Schlup Santos, Belo Horizonte (BR)

(72) Inventor: Paulo Schlup Santos, Belo Horizonte (BR)

(73) Assignee: Google Inc., Mountain View, CA (US)

(21) Appl. No.: 13/493,516

(22) Filed: Jun. 11, 2012

(51) Int. Cl. G06F 15/16; G06F 3/01

(52) U.S. Cl. 715/752; 709/206

(57) ABSTRACT

A method and system for email content sharing is described. A method may comprise receiving an email including content. The method may further comprise providing an option available from an email application to share the content on a social network. The method may also comprise receiving an indication, associated with the option available from the email application, to share the content on the social network. The method may additionally comprise sharing the content on the social network by, at least in part, making the content accessible from the social network.

### TECHNICAL FIELD

The technical field may generally relate to email content sharing, and more particularly to sharing email content on an online service.

### BACKGROUND

A user may wish to share content included in an email attachment on an online service such as a social network. The user may open the attached content from the email and may save the attached content locally to a client computing device. The user may then login to a social networking account associated with the social network and with the user, and may upload the attached content to the social network. In some situations, the user may be unable to save the attached content locally to the client computing device. Also, in some situations the user may not wish to save the attached content locally to the client computing device.

### BRIEF SUMMARY

In an embodiment, a method may include receiving, at a server computing device, an email including content. The method may further include, in response to receiving an indication to share the content on a social network, providing, from, at least in part, the server computing device, a graphical user interface configured to allow selection of at least one of a user, and a group with which to share the content. The graphical user interface may be available from an email application through which the email is viewable. The method may also include receiving, at the server computing device, a selection of at least one of the user and the group with which to share the content. The method may additionally include posting, from, at least in part, the server computing device, the content to the social network without requesting a user to provide the content. Access to the content on the social network may be based upon, at least in part, the selection of at least one of the user and the group with which to share the content.

In an embodiment, a method may include receiving, at a server computing device, an email including content. The method may further include providing, from, at least in part, the server computing device, an option available from an email application to share the content on a social network. The method may also include receiving, at the server computing device, an indication, associated with the option available from the email application, to share the content on the social network. The method may additionally include sharing, from, at least in part, the server computing device, the content on the social network by, at least in part, making the content accessible from the social network.

One or more of the following features may be included. The method may include determining whether a social network account associated with the social network and with an intended recipient of the email is configured to allow the content to be shared on the social network from, at least in part, the email application. The method may further include receiving an indication from the social network that a social network account associated with the social network and with an intended recipient of the email is configured to allow the content to be shared on the social network from, at least in part, the email application. The method may also include linking an email account associated with the email application and with an intended recipient of the email to a social network account associated with the social network and with the intended recipient of the email, wherein the linking indicates that the social network account is configured to allow the content to be shared on the social network from, at least in part, the email application.

In an implementation, making the content accessible from the social network may further comprise providing a storage reference indicator associated with the content to the social network. The content may be shared on the social network from, at least in part, the server computing device without saving the content at a client computing device associated with an intended recipient of the email. The method may further comprise providing an option available from the email application to select one or more different social networks on which to share the content. The method may additionally comprise providing an option available from the email application to select at least one of one or more connections and one or more groups associated with the social network and with an intended recipient of the email with which to share the content. The content may include at least one of an attachment and a link to outside content.

In an embodiment, a computing system may include one or more processors. The one or more processors may be configured to provide, from, at least in part, the server computing device, an option available from an email application to share content included in an email on a social network. The one or more processors may also be configured to provide, from, at least in part, the server computing device, an option to allow selection of at least one of a user, and a group with which to share the content. The option may be available from an email application through which the email is viewable. The one or more processors may also be configured to receive, at the server computing device, an indication, associated with the option available from the email application, to share the to content on the social network. The one or more processors may additionally be configured to share, from, at least in part, the server computing device, the content on the social network by, at least in part, making the content accessible from the social network.

One or more of the following features may be included. The one or more processors may be configured to determine whether a social network account associated with the social network and with an intended recipient of the email is configured to allow the content to be shared on the social network from, at least in part, the email application. The one or more processors may further be configured to receive an indication from the social network that a social network account associated with the social network and with an intended recipient of the email is configured to allow the content to be shared on the social network from, at least in part, the email application. The one or more processors may also be configured to link an email account associated with the email application and with an intended recipient of the email to a social network account associated with the social network and with the intended recipient of the email, wherein the linking indicates that the social network account is configured to allow the content to be shared on the social network from, at least in part, the email application.

In an implementation, making at least one of the attachment and the link to content accessible from the social network may further comprise providing a storage reference indicator associated with the content, and content linked in the link to content to the social network. The content may be shared on the social network from, at least in part, the server computing device without saving content at a client computing device associated with an intended recipient of the email. The one or more processors may further be configured to provide an option available from the email application to select one or more different social networks on which to share the content. The one or more processors may also be configured to provide an option available from the email application to select at least one of one or more connections and one or more groups associated with the social network and with an intended recipient of the email with which to share the content. The one or more processors may further be configured to receive at least one of a comment and a description associated with the content.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example system that can execute implementations of the present disclosure;

FIG. 2 is a flowchart illustrating an example process for email content sharing in accordance with the present disclosure;

FIG. 3 depicts an example graphical user interface associated with an email content sharing process in accordance with the present disclosure;

FIG. 4 depicts an example graphical user interface associated with an email content sharing process in accordance with the present disclosure;

FIG. 5 depicts an example graphical user interface associated with an online service in accordance with the present disclosure; and

FIG. 6 is a flowchart illustrating an example process for email content sharing in accordance with the present disclosure.

### DETAILED DESCRIPTION

A user may receive an email that includes an attachment or a link to content. The user may wish to share the content included in the email attachment or the link on an online service such as a social network. For example, the user may open the attached content from the email and may save the attached content locally to a client computing device. The user may then login to a social networking account associated with the social network and with the user, and may upload the attached content to the social network. Other users who may be connected to the user via the social network, or who may belong to a group associated with the user on the social network, may access or view the content uploaded to the social network by the user.

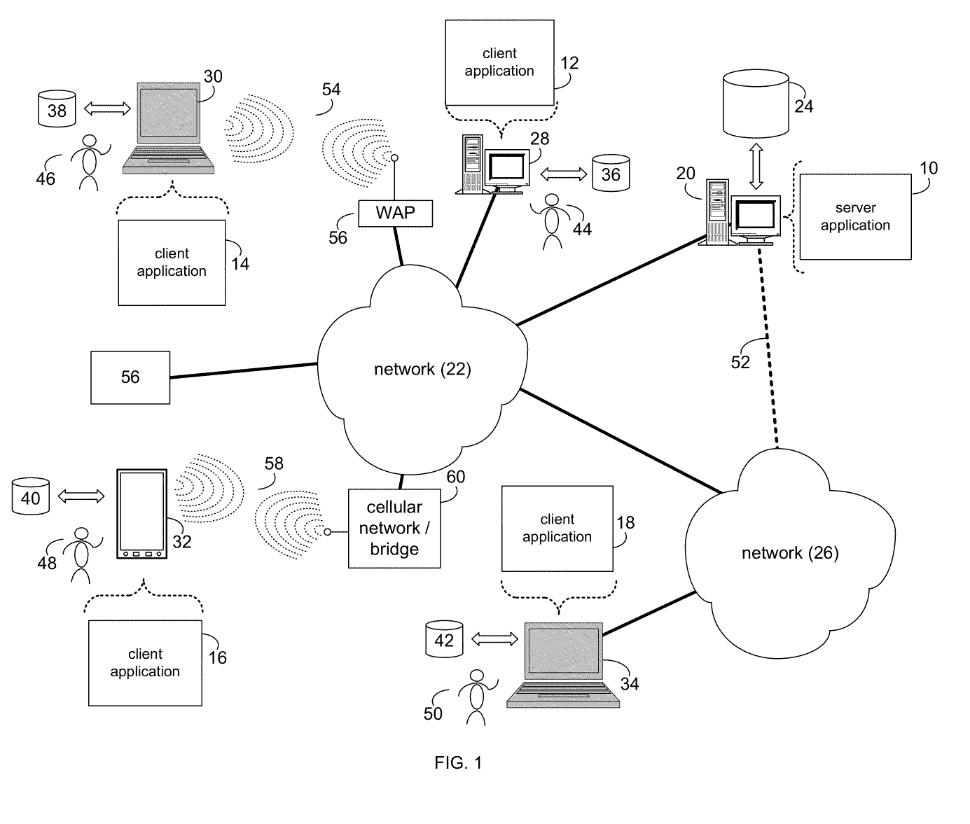

Referring to FIGS. 1 & 2, there is shown a server application 10 and client applications 12, 14, 16, and 18. Server application 10 and/or one or more of client applications 12, 14, 16, and/or 18 may execute one or more processes configured to carry out one or more of the features described herein. Server application 10 may be referred to as a process configured to carry out one or more of the features described herein, such as email content sharing process 10. Further, one or more of client applications 12, 14, 16, and 18 may be referred to as a process configured to carry out one or more of the features described herein, such as email content sharing processes 12, 14, 16, and/or 18.

As will be discussed below, email content sharing process 10 may receive 100, an email including content. Email content sharing process 10 may also provide 102 an option available from an email application to share the content on an online service. Email content sharing process 10 may further receive 104 an indication, associated with the option available from the email application, to share the content on the online service. Email content sharing process 10 may additionally share 106 the content on the online service by, at least in part, the content accessible from the online service.

The email content sharing (ECS) process may be a server-side process (e.g., server-side ECS process 10), a client-side process (e.g., client-side ECS process 12, client-side ECS process 14, client-side ECS process 16, or client-side ECS process 18), or a hybrid server-side/client-side process (e.g., a combination of server-side ECS process 10 and one or more of client-side ECS processes 12, 14, 16, 18).

Referring to FIG. 1, Server-side ECS process 10 may reside on and may be executed by server computer 20, which may be in communication with network 22 (e.g., the Internet or a local area network). Examples of server computer 20 may include, but are not limited to: a server computing device, a personal computer, a server computer, a series of server computers, a mini computer, and/or a mainframe computer. The server computer 20 may be a distributed system and the operations of server computer 20 may execute on one or more processors, simultaneously and/or serially. Server computer 20 may execute one or more operating systems, examples of which may include but are not limited to: Microsoft Windows Server™; Novell Netware™; Redhat Linux™, Unix, or a custom operating system, for example.

The instruction sets and subroutines of server-side ECS process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application that allows for access to server computer 20 (via network 22) using one or more protocols, examples of which may include but are not limited to HTTP (i.e., HyperText Transfer Protocol). Network 22 may be in communication with one or more secondary networks (e.g., network 26), examples of which may include but are not limited to: a local area network; a wide area network; or an intranet, for example.

Client-side ECS processes 12, 14, 16, 18 may reside on and may be executed by client electronic devices (i.e., client devices or client computing devices) 28, 30, 32, and/or 34 (respectively), examples of which may include but are not limited to personal computer 28, a television with one or more processors embedded therein or coupled thereto (not shown), laptop computer 30, data-enabled mobile telephone 32, notebook computer 34, a tablet (not shown), and a personal digital assistant (not shown), for example. Client electronic devices 28, 30, 32, and/or 34 may each be in communication with network 22 and/or network 26 and may each execute an operating system.

The instruction sets and subroutines of client-side ECS processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side ECS processes 12, 14, 16, 18 and/or server-side ECS process 10 may be processes that run within (i.e., are part of) a client device application, such as a mobile telephone application. Alternatively, client-side ECS processes 12, 14, 16, 18 and/or server-side ECS process 10 may be stand-alone applications that work in conjunction with the client device application. One or more of client-side ECS processes 12, 14, 16, 18 and server-side ECS process 10 may interface with each other (via network 22 and/or network 26).

Users 44, 46, 48, 50 may access server-side ECS process 10 directly through the device on which the client-side ECS process (e.g., client-side ECS processes 12, 14, 16, 18) is executed, namely client electronic devices 28, 30, 32, 34, for example. Users 44, 46, 48, 50 may access server-side ECS process 10 directly through network 22 and/or through secondary network 26. Further, server computer 20 (i.e., the computer that executes server-side ECS process 10) may be in communication with network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing a wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

For the following discussion, server-side ECS process 10 will be described for illustrative purposes. It should be noted that server-side ECS process 10 may interact with client-side ECS process 12 and may be executed within one or more applications that allow for communication with client-side ECS process 12. However, this is not intended to be a limitation of this disclosure, as other configurations are possible (e.g., stand-alone, client-side ECS processes and/or stand-alone server-side ECS processes). For example, some implementations may include one or more of client-side ECS processes 12, 14, 16, 18 in place of or in addition to server-side ECS process 10.

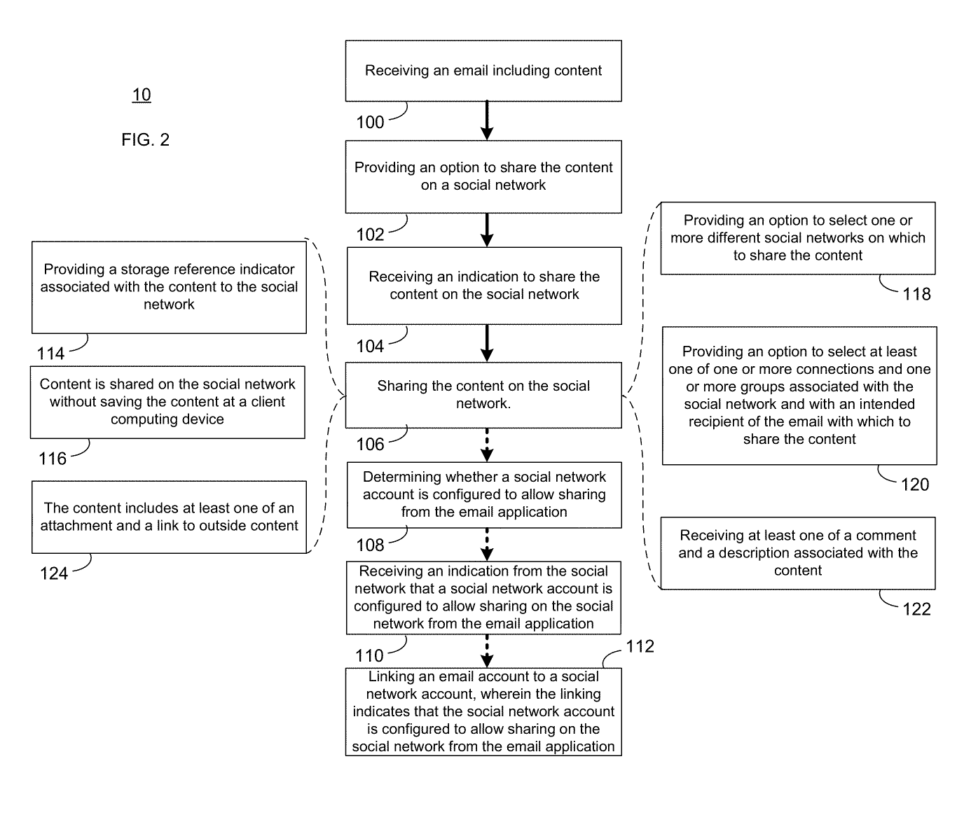

Referring now to FIGS. 1-3, ECS process 10 may receive 100 an email (e.g., email 300) including content. The content may be (124) at least one of an attachment (e.g., attachment 302) and a link (e.g., link 304) to outside content. The term content as used herein may describe any attachment, file, document, media, video, audio, text, streaming media, embedded media, embedded content, or outside content that may be attached to, linked in, or referenced in, an email. The term attachment as used herein may describe any file that may be transmitted with an email. The term outside content as used herein may describe content that is not transmitted with the email or stored with the email. Outside content may include, for example, a webpage, document, or media that may be linked in the email but stored elsewhere.

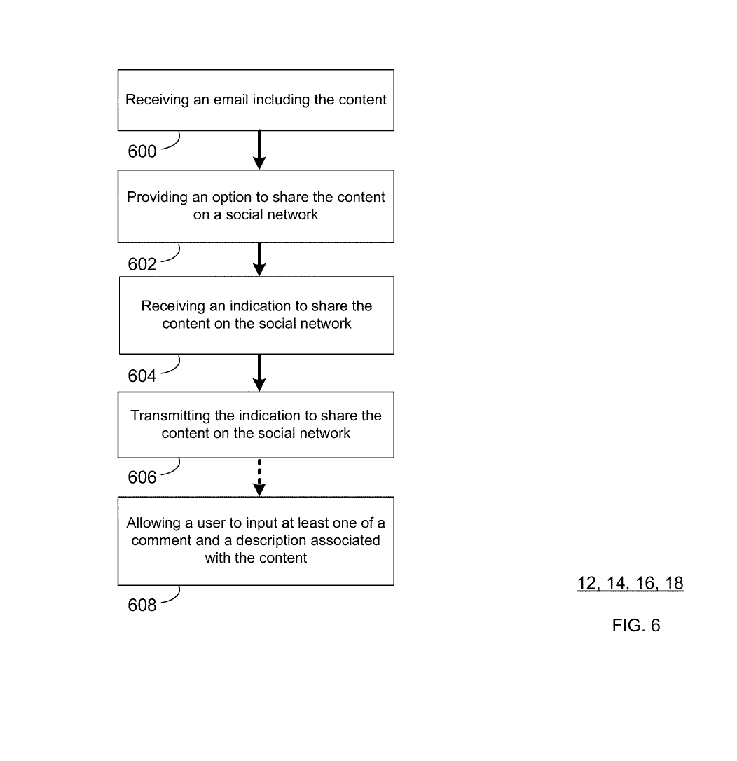

Email 300 may be received by server computer 20. Further, and referring now also to FIG. 6, email 300 may be received 600 by one or more of client electronic devices 28, 30, 32, and/or 34. In an implementation, email 300 may be initially received 100 by server computer 20, and subsequently received 600 by one or more of client electronic devices 28, 30, 32, and/or 34 while being accessed by, e.g., one or more of users 44, 46, 48, and/or 50. Email 300 may be received by an email application that may be a webmail application.

Attachment 302 may be any type of file or content that may be sent or received via email. For example, attachment 302 may be a document (e.g., text file), photograph (e.g., image file), video file, audio file or any other type of file that may be sent or received by email. Further, link 304 may be a link to a webpage or to any type of content that may be accessed by a link over a network or the internet. For example, link 304 may be a link to a news story on a website or to a file such as a document (e.g., text file), photograph (e.g., image file), video file, audio file or any other type of file that may be accessed by a link over a network or the internet.

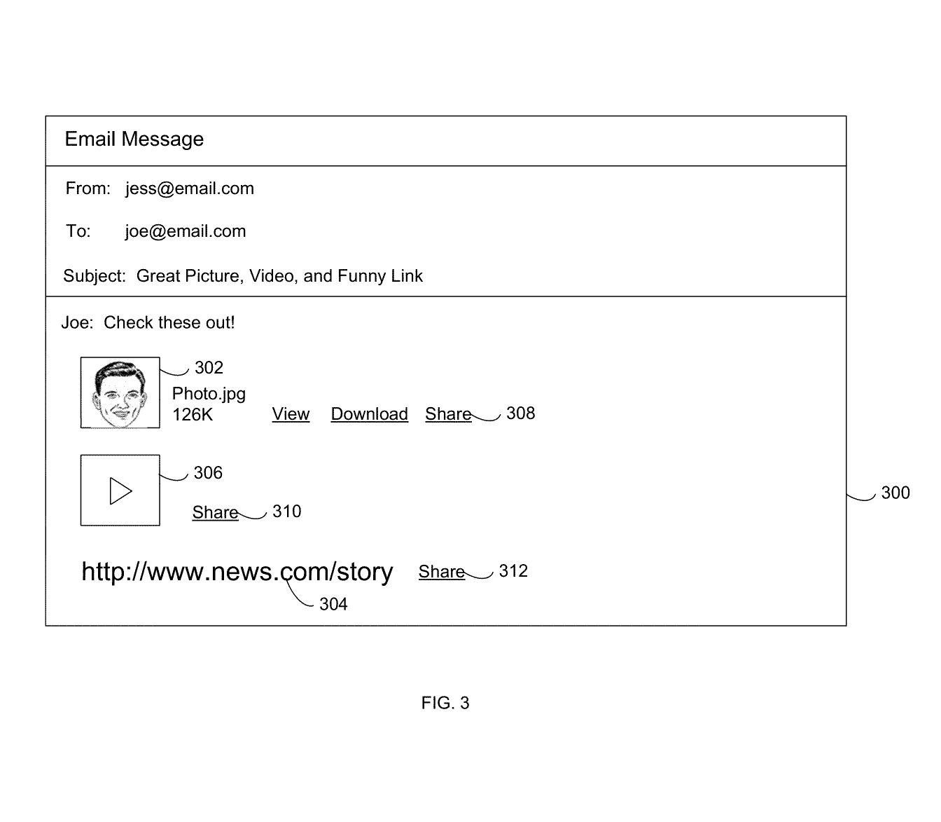

While link 304 is shown as a uniform resource locator in FIG. 3, this is for illustrative purposes only and is not intended to be a limitation of the present disclosure. For example, a link included in an email may appear as an icon or may be accessible via an applet or video player. Icon 306, for example, may have been sent in the email as a link but an email application through which email 300 is accessed may determine that the link is to a video. The email application may be configured to show the link as an icon and allow the video to be accessed (e.g., played or rendered) via the icon (e.g., 306). Selection of icon 306 may activate an applet or video player configured to render the content (e.g., the linked video).

Continuing with the example above, ECS process 10 may provide 102 an option (e.g., options 308, 310, and/or 312) available from an email application to share the content (e.g., attachment 302 and/or link 304) on an online service. The online service may be a social network or any other application available online configured to allow one or more users to share or post content. For example, the online service may be a blog, website, or other medium through which content may be shared. It should be noted that while some of the examples discussed below are discussed with respect to a social network, this is not intended to be a limitation of the present disclosure. The techniques and features described herein may be used with respect to online services in general, as discussed above.

Options 308, 310, and/or 312 may correspond to the content (e.g., attachment 302 or link 304) and may appear in close proximity to the attachment (e.g., attachment 302) or link (e.g., link 304) to content. While options 308, 310, and/or 312 are shown as the selectable text “share”, this is for illustrative purposes only and is not intended to be a limitation of the present disclosure. For example, one or more of options 308, 310, and/or 312 be provided in the form of any graphical user interface element or control, including, but not limited to, a button, drop-down list, list box, check box, radio button, or icon. Additionally, one or more of options 308, 310, and/or 312 may be selectable via a keyboard shortcut.

Assume for illustrative purposes that user 48 views email 300 via client electronic device 32. An email application associated with email process 10 may provide one or more of options 308, 310, and/or 312. A selection of one or more of options 308, 310, and/or 312 may allow user 48 to share the content. For example, the content may be attachment 302, content associated with icon 306 (e.g., video content) and/or content associated with link 304, respectively. One or more of attachment 302, content associated with icon 306 (e.g., video content) and/or content associated with link 304 may be shared to an online service upon ECS process 10 receiving an indication of a selection of one or more of options 308, 310, and/or 312.

One or more of options 308, 310, and/or 312 may be provided 102 by server computer 20. Further, and referring also to FIG. 6, one or more of options 308, 310, and/or 312 may provided 602 by one or more of client electronic devices 28, 30, 32, and/or 34. For example, ECS process 10 may provide 102, via server computer 20, one or more of options 308, 310, and/or 312 to one or more of client electronic devices 28, 30, 32, and/or 34. Further, one or more of ECS processes 12, 14, 16, and/or 18 may provide 602 one or more of options 308, 310, and/or 312 to, e.g., one or more of users 44, 46, 48, and/or 50.

Further, ECS process 10 may receive 104 an indication, associated with the option (e.g., options 308, 310, and/or 312) available from the email application, to share the content (e.g., attachment 302 or link 304) on an online service (e.g., social network). The indication may be received in response to one or more of users 44, 46, 48, and/or 50 selecting one or more of options 308, 310, and/or 312. Further, the indication may be received in response to one or more of users 44, 46, 48, and/or 50 selecting one or more other options subsequently available after selection of one or more of options 308, 310, and/or 312. The indication may be received 104 by ECS process 10 at server computer 20 from, e.g. one or more of client electronic devices 28, 30, 32, and/or 34.

Further, and referring also to FIG. 6, the indication may be received 604 by one or more of ECS processes 12, 14, 16, and/or 18 at one or more of client electronic devices 28, 30, 32, and/or 34 in response to one or more of users 44, 46, 48, and/or 50 selecting one or more of options 308, 310, and/or 312, or in response to one or more of users 44, 46, 48, and/or 50 selecting one or more other options subsequently available after selection of one or more of options 308, 310, and/or 312. Additionally, one or more of ECS processes 12, 14, 16, and/or 18 may transmit 606 the indication, associated with the option available from the email application, to share the content (e.g., attachment 302 or link 304) on the social network to server computer 20.

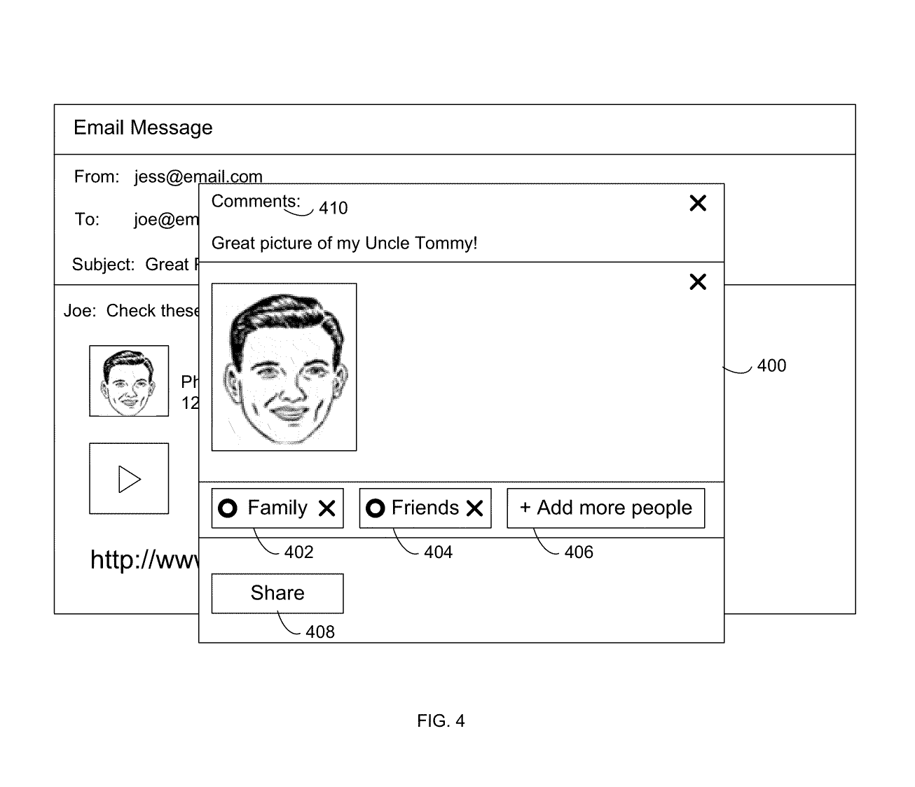

For example, and referring now also to FIG. 4, in response to receiving an indication that one or more of users 44, 46, 48, and/or 50 selected one or more of options 308, 310, and/or 312, ECS process 10 may provide or display graphical user interface 400. Graphical user interface 400 may be provided by ECS process 10 via server computer 20 to, e.g., one or more of client electronic devices 28, 30, 32, and/or 34 in response to one or more of users 44, 46, 48, and/or 50 selecting one or more of options 308, 310, and/or 312. Further, graphical user interface 400 may be provided by one or more of ECS processes 12, 14, 16, and/or 18 at one or more of client electronic devices 28, 30, 32, and/or 34, in response to receiving an indication that one or more of users 44, 46, 48, and/or 50 selected one or more of options 308, 310, and/or 312. Graphical user interface 400 may be associated with an email application and may provide one or more other options subsequently available after selection of one or more of options 308, 310, and/or 312, including, but not limited to, options 402, 404, 406, and/or 408.

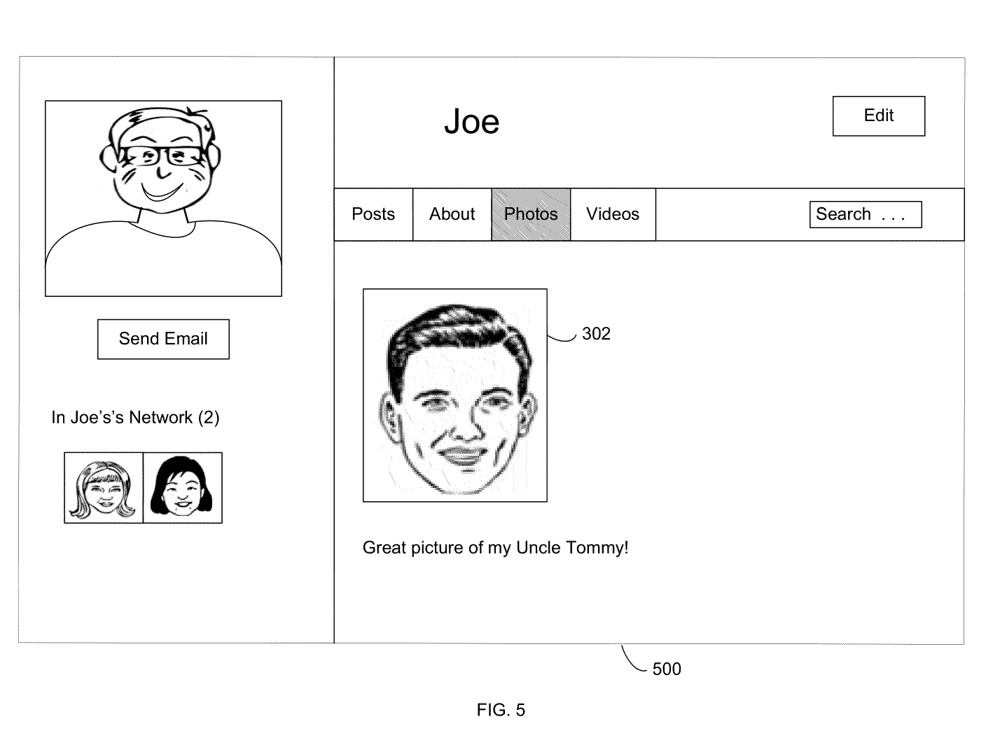

Continuing with the above example, ECS process 10 may share 106 the content (e.g., attachment 302 or link 304) on the online service (e.g., social network) by, at least in part, making the content (e.g., attachment 302 or link 304) accessible from the online service (e.g., social network). Referring now also to FIG. 5, graphical user interface 500 is shown. Graphical user interface 500 may be associated with a social network or social network account and may allow a user to access or interact with the a social network or social network account. For example, in response to receiving an indication that, e.g., user 48 selected option 408, ECS process 10 may share (e.g., post) attachment 302 to the a social network or social network account associated with graphical user interface 500.

It should be noted that the content may be edited or transformed by the user or automatically by the ECS process 10 before the content is shared. For example, images may be resized, rotated, grouped together or transformed into a slideshow. One or more features for editing or transforming the content may be available from in the email application, the online service interface or API, or an external application. For example, a mobile phone application may be configured to add a filter to image attachments before sharing, or the images may be automatically resized to the online service's maximum allowed dimensions. Further, the content may be transcoded into a different file format (e.g., from Bitmap/.bmp to JPEG/.jpg).

ECS process 10 may share (e.g., post) attachment 302 to the online service (e.g., social network) without requiring, e.g., user 48 to save attachment 302 to, e.g., client electronic device 32. For example, ECS process 10 may provide 114 a storage reference indicator associated with the content (e.g., attachment 302 or link 304 or content linked in the link 304) to the social network. The storage reference indicator may indicate, at least in part, where the content (e.g., attachment 302, link 304 to content, and/or content linked in the link) is stored. The storage reference indicator may indicate that, e.g., attachment 302 has an address or unique identifier at server computer 20 or in a database accessible by server computer 20. In other words, the storage reference indicator may uniquely identify how to access, e.g., content associated with attachment 302.

By using this information indicating how to access attachment 302, ECS process 10 may share attachment 302 on the online service (e.g., social network) without saving (116) attachment 302 to a client electronic device associated with an intended recipient of the email. For example, ECS process 10 may copy attachment 302 in order to post, upload, or otherwise share attachment 302 on the social network. ECS process 10 may also reference the address or unique identifier on the social network to make attachment 302 accessible on the social network. In an implementation, ECS process 10 may send an indication of the address or unique identifier associated with the content to the user to allow the user to see what has been or will be shared. Also, ECS process 10 may provide a message to the user indicating that the content has been shared or posted on the online service, and may also provide a link to the user that may allow the user to access or view the shared or posted content. Additionally, ECS process 10 may notify the sender of the email including the content (e.g., “jess@email.com” in FIG. 3) that the content has been shared. The sender may receive a link allowing the sender to access the posted content. For example, the intended recipient of the email including the content who may decide to share the content on the online service may (via, e.g., graphical user interface 400) be enabled by ECS process 10 to select an option (e.g., via a checkbox) to send the notification to the sender.

In an implementation, ECS process 10 may determine 108 whether an online service (e.g., social network) account associated with the online service (e.g., social network) and with an intended recipient of the email is configured to allow the content (e.g., attachment 302 or link 304) the be shared on the online service (e.g., social network) from, at least in part, the email application. One or more of an email application associated with ECS process 10 or the social network over which the content is to be shared may require the user to opt-in or make a special selection in order to allow the user to share attached content or links from the email application to the social network. In response to receiving the selection, which may be made through one or more of the email application associated with ECS process 10 or the online service (e.g., social network), ECS process 10 may link 112 the email account associated with the email application and with the intended recipient of the email to an online service (e.g., social network) account associated with the online service (e.g., social network) and with the intended recipient of the email. The linking may indicate that the online service (e.g., social network) account is configured to allow the content (e.g., attachment 302 or link 304) be shared on the online service (e.g., social network) from, at least in part, the email application. In an implementation where the email application and online service are administered by the same organization, the link between the email application and online service may be automatically configured by ECS process 10.

Further, ECS process 10 may receive 110 an indication from the online service (e.g., social network) that an online service (e.g., social network) account associated with the online service (e.g., social network) and with an intended recipient of the email is configured to allow the content (e.g., attachment 302 or link 304) to be shared on the online service (e.g., social network) from, at least in part, the email application. In an implementation, ECS process 10 may enable options 402, 404, 406, and/or 408 or otherwise make options 402, 404, 406, and/or 408 available to the user in response to receiving 110 the indication.

In an implementation, ECS process 10 may provide 118 an option available from the email application to select one or more different online services (e.g., social networks) on which to share the content (e.g., attachment 302 or link 304). For example, one or more of users 44, 46, 48, and/or 50 may have multiple online service (e.g., social networks) that they use. ECS process 10 may provide, via, e.g., graphical user interface 400 a list of online services (e.g., social networks) though which the user may share attachment 302. Each online service (e.g., social network) on the list may have been approved or configured by the user.

In an implementation, ECS process 10 may provide 120 an option available from the email application to select at least one of one or more connections (e.g., friends or connected users) and one or more groups associated with the online service (e.g., social network) and associated with an intended recipient of the email with which to share the content (e.g., attachment 302 or link 304). For example, and as shown in FIG. 4, ECS process 10 may provide option 406 (e.g., “+Add more people”) via graphical user interface 400. In response to receiving a selection of option 406, ECS process 10 may render another graphical user interface which may list one or more other users who are connections of the user making the selection. Additionally, ECS process 10 may provide one or more of options 402 and 404 via graphical user interface 400. In response to receiving a selection of option 402, ECS process 10 may allow the user to share the content (e.g., attachment 302 or link 304) with one or more users in the group “Family”. Further, in response to receiving a selection of option 404, ECS process 10 may allow the user to share the content (e.g., attachment 302 or link 304) with one or more users in the group “Friends.”

In an implementation, one or more of ECS processes 12, 14, 16, and/or 18 may allow 608 a user to input at least one of a comment and a description associated with the content (e.g., attachment 302 or link 304). Referring again to FIG. 4, the user may enter a comment in comment section 410. The comment may be a comment about the attachment or content included and the description may describe the attachment or content included. Further, ECS process 10 may receive 122 at least one of the comment and the description associated with the content.

In an implementation, both the email application and the online service (e.g., social network) may be operated by the same organization. In this situation the content (e.g., the attachment or link) may be stored by the same organization or may be accessible by the same organization by using the reference storage indicator, as described above. Also, in an implementation, the email application and the online service (e.g., social network) may not be operated by the same organization. In this situation, the online service (e.g., social network) may transfer the content (e.g., the attachment or link) from one server (e.g., associated with the email application) to another server (e.g., associated with the social network application) so that it may be shared.

In an implementation, ECS process 10 may use an application programming interface (API) to share the content (e.g., the attachment or link) from the email application to the online service (e.g., social network). Further, in some situations, the online service (e.g., social network) may not recognize a file type of the attachment or link to content. The online service (e.g., social network) may reject the file and may be configured to accept some attachments but not others.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by, or to control the operation of, a data processing apparatus. The computer readable medium can be a machine-readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions or computer program products and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These may also be referred to as computer readable storage media. The processor and the memory can be supplemented by, or incorporated in, special purpose logic circuitry.

To provide for interaction with a user, implementations of described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file or transmitted HTML content is mentioned, other file types or formats may be substituted. For instance, an HTML file may be replaced by an XML, JSON, plain text, or other types of files. Moreover, where a table or hash table is mentioned, other persistent or non-persistent data structures (such as spreadsheets, relational databases, or structured files) may be used.

A number of embodiments and implementations have been described. Nevertheless, it will be understood that various modifications may be made. Accordingly, other embodiments and implementations are within the scope of the following claims. For example, the actions recited in the claims can be performed in a different order and still achieve desirable results.

1. A computer-implemented method comprising:
receiving, at a server computing device, an email including content;
in response to receiving an indication to share the content on a social network, providing, from, at least in part, the server computing device, a graphical user interface configured to allow selection of at least one of a user, and a group with which to share the content, wherein the graphical user interface is available from an email application through which the email is viewable, wherein at least one of the user and the group is associated with and provided by the social network;
receiving, at the server computing device, a selection of at least one of the user and the group with which to share the content, wherein at least one of the user and the group is selected via the email application; and
posting, from, at least in part, the server computing device, the content to the social network without requesting an intended recipient of the email to provide the content, wherein access to the content on the social network is based upon, at least in part, the selection of at least one of the user and the group with which to share the content.

2. A computer-implemented method comprising:
receiving, at a server computing device, an email including content;
providing, from, at least in part, the server computing device, an option available from an email application to share the content on a social network, the option including at least one of one or more connections and one or more groups associated with and received fromprovided by the social network, wherein at least one of the one or more connections and the one or more groups are selected via the email application;
receiving, at the server computing device, an indication, associated with the option available from the email application, to share the content on the social network; and
sharing, from, at least in part, the server computing device, the content on the social network by, at least in part, making the content accessible from the social network.

3. The computer-implemented method of claim 2, further comprising:
determining whether a social network account associated with the social network and with an intended recipient of the email is configured to allow the content to be shared on the social network from, at least in part, the email application.

4. The computer-implemented method of claim 2, further comprising:
receiving an indication from the social network that a social network account associated with the social network and with an intended recipient of the email is configured to allow the content to be shared on the social network from, at least in part, the email application.

5. The computer-implemented method of claim 2, further comprising:
linking an email account associated with the email application and with an intended recipient of the email to a social network account associated with the social network and with the intended recipient of the email, wherein the linking indicates that the social network account is configured to allow the content to be shared on the social network from, at least in part, the email application.

6. The computer-implemented method of claim 2, wherein making the content accessible from the social network further comprises:
providing a storage reference indicator associated with the content to the social network, wherein the storage reference indicator indicates, at least in part, where the content is stored.

7. The computer-implemented method of claim 2, wherein the content is shared on the social network from, at least in part, the server computing device without saving the content at a client computing device associated with an intended recipient of the email.

8. The computer-implemented method of claim 2, further comprising:
providing an option available from the email application to select one or more different social networks on which to share the content.

9. (canceled)

10. The computer-implemented method of claim 2, further comprising:
receiving at least one of a comment and a description associated with the content.

11. The computer-implemented method of claim 2, wherein the content includes at least one of an attachment and a link to outside content.

12. A computing system comprising one or more processors, wherein the one or more processors are configured to:
provide, from, at least in part, a server computing device, an option available from an email application to share content included in an email on a social network;
provide, from, at least in part, the server computing device, an option to allow selection of at least one of a user, and a group with which to share the content, wherein the option is available from the email application, wherein at least one of the user and the group is associated with and received from provided by the social network, wherein at least one of the user and the group is selected via the email application;
receive, at the server computing device, an indication, associated with the option available from the email application, to share the content on the social network; and
share, from, at least in part, the server computing device, the content on the social network by, at least in part, making the content accessible from the social network.

13. The computing system of claim 12, wherein the one or more processors are further configured to:
determine whether a social network account associated with the social network and with an intended recipient of the email is configured to allow the content to be shared on the social network from, at least in part, the email application.

14. The computing system of claim 12, wherein the one or more processors are further configured to:
receive an indication from the social network that a social network account associated with the social network and with an intended recipient of the email is configured to allow the content to be shared on the social network from, at least in part, the email application.

15. The computing system of claim 12, wherein the one or more processors are further configured to:
link an email account associated with the email application and with an intended recipient of the email to a social network account associated with the social network and with the intended recipient of the email, wherein the linking indicates that the social network account is configured to allow the content to be shared on the social network from, at least in part, the email application.

16. The computing system of claim 12, wherein making the content accessible from the social network further comprises:
providing a storage reference indicator associated with the content to the social network, wherein the storage reference indicator indicates, at least in part, where the content is stored.

17. The computing system of claim 12, wherein the content is shared on the social network from, at least in part, the server computing device without saving the content at a client computing device associated with an intended recipient of the email.

18. The computing system of claim 12, wherein the one or more processors are further configured to:
provide an option available from the email application to select one or more different social networks on which to share the content.

19. The computing system of claim 12, wherein the one or more processors are further configured to:
receive at least one of a comment and a description associated with the content.

20. The computing system of claim 12, wherein the content includes at least one of an attachment and a link to outside content.
